(19) United States
(12) Patent Application Publication
(10) Pub. No.: US 2011/0045203 A1
(43) Pub. Date: Feb. 24, 2011

(54) PROCESS FOR INHIBITING OXIDE FORMATION ON COPPER SURFACES

(75) Inventors: Michael Joseph Grovola, Middletown, DE (US); Jeffery Scott Thompson, West Chester, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/545,313

(22) Filed: Aug. 21, 2009

(51) Int. Cl. B05D 3/06; B05D 3/02; B05D 3/00; C09D 5/08; C09D 5/00

(52) U.S. Cl. 427/535; 427/352; 427/384; 106/14.42; 106/287.21

(57) ABSTRACT

Processes are provided for inhibiting the formation of copper oxides on substantially oxide-free copper surfaces by contacting a substantially oxide-free copper surface with a pyrazoline ligand in an aqueous solution of pH 2-5. A thin layer of the ligand formed by coordination of 2-pyrazoline or 1-methyl-2-pyrazoline to the copper surface can be easily removed by exposure to a reducing plasma to regenerate a substantially oxide-free copper surface.

### FIELD OF THE INVENTION

The present invention relates to processes for inhibiting oxide formation of copper surfaces exposed to air.

### BACKGROUND

The manufacture of ultra-large scale integrated circuits typically involves a chemical-mechanical planarization (CMP) step in which a patterned copper surface is subjected to a polishing process using a combination of abrasives and chemical agents. This CMP step is typically followed by a post-CMP clean step (PCMP) to remove residues left by the CMP step from the semiconductor work-piece surface without significantly etching the metal, leaving deposits on the surface, or imparting significant organic carbonaceous contamination to the semiconductor work-piece. Ideally, the cleaned work-piece proceeds immediately after the PCMP process into a vacuum environment for the next step of the manufacturing process. Because of queue time-related delays between wet and dry tools, work-pieces coming out of PCMP clean do not always promptly enter a vacuum (air-free) environment for the next process step and surface copper oxide formation occurs. Copper oxide compromises device performance and must be removed from the copper surface prior to the deposition of the next layer in the preparation of copper interconnects on semiconductor chips. In the dual damascene process, the next layer is typically a silicon nitride cap layer deposited by plasma enhanced chemical vapor deposition (PECVD).

The copper oxide layer is currently removed from the copper surface following PCMP cleaning steps by a plasma clean process. Although this plasma clean is effective, the exposure of the dielectric material surrounding the copper lines to the plasma during the cleaning cycle damages the dielectric material. With the introduction of more fragile low k dielectric materials in current and future generations of chips, this damage could be significant and could change the dielectric properties of the material, leading to failures.

In another step in chip fabrication, the semiconductor wafer is etched to create a pattern of vias and interconnect lines, followed by cleaning with a post-etch residue (PER) remover to clean the wafer of any debris resulting from the etching step. Copper lines exposed during the etching step are susceptible to copper oxide formation on contact with the ambient atmosphere. As in the case of PCMP cleaning, any copper oxide formed must be removed prior to deposition of the next layer, usually a barrier layer followed by copper layers. Typically, the copper oxide layer is removed via a plasma clean step that can damage the dielectric layer.

Copper surfaces exposed following PCMP cleaning and PER removal are susceptible to oxidation owing to the exposure of the copper surface to the ambient atmosphere.

A process is needed to prevent the formation of copper oxide on semiconductor work-pieces that is compatible with chip manufacturing processes and that does not damage sensitive dielectric layers.

### SUMMARY OF THE INVENTION

One aspect of the invention is a process comprising contacting a substantially oxide-free copper surface with an aqueous solution comprising a pyrazoline ligand and an organic acid to form a copper surface coated with a layer of the pyrazoline ligand, wherein the pyrazoline is 2-pyrazoline or 1-methyl-2-pyrazoline or a combination thereof, and the pH of the solution is about 2 to about 5.5.

Another aspect of the invention is a process for forming substantially oxide-free copper surfaces comprising contacting a substantially oxide-free copper surface with an aqueous solution comprising pyrazoline ligand and an organic acid to form a copper surface coated with a layer of the pyrazoline ligand, wherein the pyrazoline is 2-pyrazoline or 1-methyl-2-pyrazoline or a combination thereof, and the pH of the solution is about 2 to about 5.5; rinsing and/or drying the coated copper surface; and removing the pyrazoline ligand from the pyrazoline ligand coated copper surface by exposure to reducing plasma to regenerate a substantially oxide-free copper surface.

Another embodiment is an aqueous solution comprising pyrazoline ligand, an organic acid, and one or more additives selected from the group consisting of metal-chelating agents, corrosion-inhibiting compounds, surfactants, organic solvents, fluorides, fluoride equivalents, and phosphate-containing chelators, wherein the pyrazoline is 2-pyrazoline or 1-methyl-2-pyrazoline or a combination thereof, and the pH of the solution is about 2 to about 5.5.

### DETAILED DESCRIPTION

It has been discovered that contacting a substantially oxide-free copper surface with a pyrazoline in an aqueous solution of pH about 2 to about 5.5 creates a thin layer of the pyrazoline on the copper surface that inhibits the formation of copper oxides and that can be easily removed by exposure to a reducing plasma to regenerate a substantially oxide-free copper surface. By “regenerate, as used herein, is meant “to form or create again.” Specifically, the copper surface starts out as “oxide-free,” and is then treated to create a thin layer of pyrazoline on the copper surface. That layer provides protection for the copper surface by inhibiting the formation of copper oxides, but is removed before the copper surface is used for other purposes or in other processes (e.g., coating with another metal or more copper). Treatment with, for example, plasma removes the layer of pyrazoline, “regenerating” the oxide-free copper surface.

Typically, the layer, also referred to herein as a “thin layer”, of the pyrazoline is from one monolayer to several monolayers thick. Preferably, the thin layer is from about 5 to about 50 Angstroms thick.

By “substantially oxide-free” is meant that less than 2 atom % of the copper surface atoms are coordinated to oxygen. At this coverage, the oxygen level is below the X-ray photoelectron spectroscopy (XPS) detection limit. Substantially oxide-free copper surfaces can be obtained by processes known in the art, such as treatment with acidic solution, plasma treatment, or electrochemical reduction.

A pyrazoline is used to form a thin organic layer on an oxide-free copper surface that then prevents formation of a copper oxide layer. Suitable pyrazolines include 2-pyrazoline and 1-methyl-2-pyrazoline and combinations thereof. In one embodiment, the pyrazoline is present in an amount of 0.08 to 5.0 wt %, based on the total weight of the aqueous solution. In another embodiment, the compound is present in an amount of 0.1 to 2.5 wt %, preferably 0.2 to 1.0 wt %, based on the total weight of the aqueous solution.

In one embodiment, the aqueous solution contains metal-chelating agents and one or more additives selected from the group consisting of organic solvents, corrosion-inhibiting compounds, and surfactants. Such aqueous solutions can be used as PCMP cleaning solutions.

Suitable metal-chelating agents include, but are not limited to, (ethylenedinitrilo)tetraacetic acid (EDTA), terpyridine, citric acid, gluconic acid, gallic acid, pyrogallol, oximes such as salicylaldoxime, 8-hydroxyquinoline, polyalkylenepolyamines, crown ethers, oxalic acid, maleic acid, malonic acid, malic acid, tartaric acid, aspartic acid, benzoic acid, gluconic acid, glycolic acid, succinic acid, salts of the aforementioned acids or mixtures of the acids or their salts, acetylacetone, glycine, dithiocarbamates, amidoximes, catechol, and cysteine. The metal-chelating agents are typically present in amounts of 500 ppm to 10 wt %, based on the total weight of the aqueous solution. In other embodiments, the metal-chelating agents are present in amounts of 1.0 to 7.5 wt % or 1.5 to 5.0 wt %, based on the total weight of the aqueous solution.

Suitable organic solvents include alkyl alcohols such as ethanol and isopropanol. The organic solvents are present in amounts of 5 to 20 wt %, based on the total weight of the aqueous solution. In other embodiments, the organic solvents are 1.5 to 12 wt %, or 3 to 10 wt %, based on the total weight of the aqueous solution.

Suitable surfactants include cationic, anionic, amphoteric, and non-ionic surfactants including polyethylene glycols, polypropylene glycols, fluorosurfactants, polydimethysiloxane polymers and oligomers, polydimethylsiloxane ethylene oxide and propylene oxide block co-polymers and oligomers, carboxylic acid salts, cellulosic surfactants such as hydroxypropylmethylcellulose and methylcellulose, polyalkylglycolethers, alkyl and aryl sulfonic acids, polyethyleneglycol alkyl ethers such as Brij® or Triton® surfactants (available from Sigma Aldrich, St. Louis, Mo.) and phosphate-based surfactants. In one embodiment, the surfactants are present in amounts of 0.5 to 5.0 wt %, based on the total weight of the aqueous solution. In other embodiments, the surfactants are present in amounts of 0.01 to 0.2 wt %, or 0.02 to 0.1 wt %, based on the total weight of the aqueous solution.

In another embodiment, the aqueous solution further comprises one or more additives selected from the group consisting of corrosion-inhibiting compounds and surfactants. Suitable corrosion-inhibiting compounds include azoles such as benzotriazole, 1,2,4-triazole, and imidazole; thiols such as mercaptoethanol, mercaptopropionic acid, mercaptothiazoline, mercaptobenzothiazol, and thiolglycerol; and organic reducing agents such as ascorbic acid, hydroquinone, caffeic acid, glucose, tannic acid, methoxyphenol, and resorcinol. In one embodiment, the corrosion-inhibiting compounds are typically present in amounts of 0 ppm to 5.0 wt %, based on the total weight of the aqueous solution. In other embodiments, the corrosion-inhibiting compounds are present in amounts of 0 to 2.5 wt %, or 0 to 1.0 wt %, based on the total weight of the aqueous solution.

In another embodiment, the aqueous solution comprises a pyrazoline, a fluoride or fluoride equivalent, a water miscible organic solvent, and an acid comprising one or more carboxylate moieties, wherein the pH of the solution is about 2 to about 5.5. Such an aqueous solution is useful as a PER cleaning solution and can further comprise corrosion-inhibiting agents and/or phosphonate-containing chelators. Suitable fluorides and fluoride equivalents include fluoride-containing acids and metal-free salts thereof. The term “metal-free salt of a fluoride-containing acid” as used herein means that the salt anion (or cation) does not contain a metal (e.g., sodium or potassium). Suitable salts include those formed by combining a fluoride-containing acid such as hydrogen fluoride, tetrafluoroboric acid, and/or trifluoroacetic acid, with any of: ammonium hydroxide; a C₁-C₄ alkyl quaternary ammonium ion, such as tetramethylammonium, tetraethylammonium or trimethyl(2-hydroxyethyl)ammonium; or a primary, secondary or tertiary amine, such as monoethanolamine, 2-(2-aminoethylamino)ethanol, diethanolamine, 2-ethylaminoethanol or dimethylaminoethanol. In one embodiment, the fluorides or fluoride equivalents are typically present in amounts of 0.005 to 0.6 wt %, based on the total weight of the aqueous solution. In other embodiments, the fluorides or fluoride equivalents are present in amounts of 0.0175 to 0.043 wt %, or 0.0175 to 0.038 wt %, based on the total weight of the aqueous solution.

In one embodiment, the aqueous solution contains one or more acids to achieve and maintain the pH between about 2 and about 5.5. Preferred organic acids are carboxylic acids, e.g., mono-, di- and/or tri-carboxylic acids optionally substituted in a beta position with a hydroxy, carbonyl or amino group. Organic acid species useful in the composition include but are not limited to formic acid, acetic acid, propanoic acid, butyric acid and the like; hydroxy-substituted carboxylic acids including but not limited to glycolic acid, lactic acid, tartaric acid and the like; oxalic acid; carbonyl substituted carboxylic acids including but not limited to glyoxylic acid, and the like; amino substituted carboxylic acids including but not limited to glycine, hydroxyethylglycine, cysteine, alanine and the like; cyclic carboxylic acids including but not limited to ascorbic acid and the like; oxalic acid, nitrilotriacetic acid, citric acid, and mixtures thereof. Mono- and dicarboxylic acids having between 1 and 8 carbon atoms, preferably between 2 and 6 carbon atoms, and are substituted in an alpha, beta, or both positions with a hydroxyl and/or carbonyl group, are preferred organic acids. More preferred are organic acids with a carbonyl group substituted on the carbon adjacent to the carboxyl group carbon. Exemplary preferred organic acids are oxalic acid, glyoxylic acid, citric acid, glycolic acid, or mixtures thereof. In selected embodiments, the organic acids are present in amounts of 2 to 10 wt %, or 2.7 to 10 wt %, or 2 to 4 wt %, based on the total weight of the aqueous solution.

Suitable water-miscible organic solvents include: dimethyl sulfoxide; ethylene glycol; organic acid alkyl (e.g., C₁-C₆) esters, such as ethyl lactate; ethers, such as ethylene glycol alkyl ether, diethylene glycol alkyl ether, triethylene glycol alkyl ether, propyleneglycol, and propylene glycol alkyl ether; N-substituted pyrrolidones, such as N-methyl-2-pyrrolidone; sulfolanes; dimethylacetamide; and any combination thereof. In one embodiment where a polar organic solvent is present, the boiling point of the polar organic solvent is at least about 85° C., alternatively at least about 90° C., or at least about 95° C. In one embodiment, the water-miscible solvents are present in amounts of 1 wt % to less than 20 wt %, based on the total weight of the aqueous solution. In other embodiments, the water-miscible solvents are present in amounts of 1.5 to 12 wt %, or 3 to 10 wt %, based on the total weight of the aqueous solution.

Suitable phosphonate-containing chelators include amino trimethylphosphonic acid, hydroxyethylidene 1,1-diphosphonic acid, hexamethylenediaminetetramethylene phosphonic acid, diethylenetriamine pentamethylene phosphonic acid, bishexamethylenetriamine pentamethylene phosphonic acid, and hydroxyethylidene-1,1-diphosphonic acid (DQUEST™ 2010). In one embodiment, the chelating agent, if present, is present in amounts from about 0.01 to about 5 wt %, based on the total weight of the aqueous solution. In other embodiments, the chelating agent is present in amounts from about 0.01 to 0.2 wt %, or 0.02 to 0.1 wt %, based on the total weight of the aqueous solution.

In one embodiment, a substantially oxide-free copper surface is contacted with an aqueous solution of pH about 2 to about 5.5 that comprises a pyrazoline for a sufficient period of time to form a copper surface coated with a thin layer of the pyrazoline.

In a further embodiment, the coated copper surface is rinsed to remove excess solution and optionally dried.

Surface oxide (e.g., Cu₂O and/or CuO) is not observed over exposure times up to 48 hours or longer on copper surfaces treated with solutions containing a pyrazoline. The coating can be removed with brief plasma cleaning. Treatment of an oxide-free copper surface with an aqueous solution comprising an acid and 2-pyrazoline and/or 1-methyl-2-pyrazoline can prevent deep oxide formation on the copper surface, as shown by XPS (x-ray photoelectron spectroscopy) and linear sweep voltammetry analyses of surfaces. Because the thin layer of the pyrazoline can be removed by in a reducing (e.g., N₂/H₂) plasma, the surface protection and coating removal steps can be integrated into the PECVD nitride cap step.

In one embodiment, a pyrazoline is used to create a thin layer of the ligand on the copper surface during the PCMP cleaning process. The ligand can be added to the aqueous PCMP cleaning solution at the start of the cleaning process, during the cleaning process, or after the cleaning process. The cleaning process involves contacting the wafer with cleaning solution for a period of time with sonication or other means of agitation followed by rinsing with water and/or organic solvents. If the pyrazoline is added after the cleaning process, an aqueous solution with pH between about 2 and about 5.5 that contains the ligand is added to cleaning solution. Acid is added as needed to adjust and maintain the solution pH between about 2 and about 5.5. Excess aqueous solution is removed from the subsequent rinse step.

In another embodiment, the pyrazoline is used to create a thin layer of the ligand on the copper surface during the PER cleaning process. The ligand can be added to the aqueous PER cleaning solution at the start of the cleaning cycle, during the cleaning cycle, or after the cleaning cycle. If it is added after the cleaning cycle, an aqueous solution with pH between about 2 and about 5.5 that contains the ligand is added to cleaning solution. Acid is added as needed to adjust and maintain the solution pH between 2 and 5.5. Excess aqueous solution is removed from the subsequent rinse step.

### EXAMPLES

General: Physical vapor deposited copper on-silicon wafers were obtained from Sematech. Copper foil (99.9% on metal basis, 0.127 mm thick) was obtained from Alfa Aesar (Ward Hill, Mass.). Ion-chromatography grade water from a Satorius Arium 611 DI unit (Sartorius North America Inc., Edgewood, N.Y.) was used to prepare solutions and rinse glassware prior to use. Linear sweep voltammetry studies were performed with a Bioanalytical Systems CV-50W (West Lafayette, Ind.) in 0.1 M sodium perchlorate solution (Fischer, analytical grade). This reagent was used as received. Linear sweep voltammetry studies were performed with a Model K0047 Corrosion Cell from EG&G Princeton Applied Research (Princeton, N.J.) with a K0105 flat specimen holder to hold the copper foil. A Branson 5510 ultrasonic bath (Branson Ultrasonics, Danbury, Conn.) was used to clean substrates.

Citranox from Alconox (Glenn Street, White Plains, N.Y.) is a liquid cleaner used to remove oxide and other contaminants from metal surfaces. A 2% solution is prepared diluting 20 mL of the commercial solution to 1 L with ion chromatography grade water.

X-ray photoelectron spectroscopy (XPS) studies of chemisorbed precursor were performed using a Physical Electronics PHI 5800ci spectrometer. The XPS system was under ultra-high vacuum with base pressure less than ˜5×10⁻¹⁰ torr. The instrument was operated with an Al monochromatic X-ray source. A hemi-spherical analyzer was used to collect photoelectrons. A PHI Model 06-350 ion gun and a Model NU-04 neutralizer were used to compensate for charging effects. The analytical area was at 0.8-mm diameter. The escape depth of carbon was ˜65 Å at 45° exit angle. PHI MultiPak® software version 6.0A was used for data analysis.

### Example 1

This example illustrates a process for creating an oxide-free copper surface.

A copper-on-silicon wafer was cleaned of carbonaceous materials by washing in carbon tetrachloride with sonication for 5 minutes at room temperature, followed by 2-propanol with sonication under the same conditions. The wafer was rinsed with ion-chromatography grade water and then cleaned in a 2% Citranox® solution at pH 3 with sonication for 10 minutes at 50° C. (www.alconox.com/downloads/pdf/techbull_citranox.pdf). The wafer was then thoroughly rinsed with ion-chromatography grade water saturated with argon. The wafer was then transferred to an argon-filled glove bag, rinsed with de-aerated ion-chromatograph grade water, allowed to dry under argon flow, and loaded into a transfer vessel for transport to the X-ray photoelectron spectrophotometer without exposure to the ambient atmosphere. The copper surface was analyzed by X-ray photoelectron spectroscopy and shown to be oxide-free.

### Example 2

This example demonstrates a process for creating a 2-pyrazoline layer on an oxide-free copper surface.

The procedure described in the Example 1 was repeated with copper foil held in the flat specimen holder. After a 10 minutes sonication in a 2% Citranox® solution at pH 3.0, 2-pyrazoline was added to the 2% Citranox® solution to generate a final concentration of 50 mM. The wafer was soaked in this solution for two minutes at 50° C. The wafer was then rinsed with ion-chromatography grade water and exposed to the ambient atmosphere. Linear sweep voltammetric data from −140 mV to −1100 mV (versus Ag/AgCl reference electrode) show the presence of a Cu-pyrazoline complex, but no reduction waves associated with Cu(I) and Cu(II) oxides were observed. Similar results obtained at longer exposures, up to 48 hours.

### Example 3

This example demonstrates a process for creating a 2-pyrazoline layer on an oxide-free copper surface.

The procedure described in Example 2 was repeated using a 2-4% solution of DuPont EKC 5510 post-CMP cleaner (available from E. I. du Pont de Nemours and Co., Wilmington, Del.) instead of 2% Citranox® solution. The solution pH was adjusted to 3.5 with citric acid. The copper foil was contacted with the solution at 50° C., for 8 minutes with ultrasonic cleaning. 2-Pyrazoline was then added to bring the solution concentration to 50 mM and the wafer was allowed to stand in the mixture for 2 minutes without ultrasonic agitation. The sample was then rinsed with ion chromatography grade water and air dried. The sample was exposed to the ambient atmosphere for 48 hours. Linear sweep voltammetric data from −140 mV to −1100 mV (versus Ag/AgCl reference electrode) show the presence of a Cu-pyrazoline complex, but no reduction waves associated with Cu(I) and Cu(II) oxides were observed.

### Example 4

This example demonstrates a process for creating a pyrazoline layer on an oxide-free copper surface.

The procedure described above in Example 2 was repeated, using CuSolve™ EKC520™ copper post etch residue remover as received cleaner at pH 2.25 instead of 2% Citranox® solution. (CuSolve™ EKC520™ copper post etch residue remover is available from E. l. du Pont de Nemours and Co., Wilmington, Del.) The copper foil was contacted with the solution at 50° C. for 8 minutes with ultrasonic cleaning. 2-Pyrazoline was then added to bring the solution concentration to 50 mM, and the foil was allowed to stand in the mixture for 2 minutes without ultrasonic agitation. The sample was then rinsed with ion chromatography grade water and air dried. The sample was exposed to the ambient atmosphere for up to 48 hours. Linear sweep voltammetry from −140 mV to −1100 mV (versus Ag/AgCl reference electrode) showed the presence of a Cu-2-pyrazoline complex, but no reduction waves associated with Cu(I) and Cu(II) oxides were observed.

### Comparative Example

This example demonstrates that pyrazole is not effective at maintaining an oxide-free copper surface. A copper foil was cleaned of carbonaceous materials by washing in carbon tetrachloride with sonication, followed by 2-propanol with sonication. The foil was rinsed with ion-chromatography grade water and then cleaned in a 4% solution of Citranox® at pH 3. Cleaning of the foil with this solution was performed by contacting the piece with the solution at 50° C. for 8 minutes with ultrasonic cleaning. Sonication was then discontinued. Pyrazole was added to bring the solution concentration to 50 mM, and the piece was allowed to stand in the mixture for 2 minutes without ultrasonic agitation at 50° C. The sample was then removed from the solution, rinsed with ion-chromatography grade water, and exposed to the ambient atmosphere for one hour. Analysis of the foil by linear sweep voltammetry from −140 mV to −1100 mV (versus Ag/AgCl reference electrode) showed the presence of copper oxide on the surface.

What is claimed is:

1. A process comprising contacting a substantially oxide-free copper surface with an aqueous solution comprising a pyrazoline ligand and an organic acid to form a copper surface coated with a layer of the pyrazoline ligand, wherein the pyrazoline is 2-pyrazoline or 1-methyl-2-pyrazoline or a combination thereof, and the pH of the solution is about 2 to about 5.5.

2. The process of claim 1, wherein the organic acid is selected from the group consisting of citric acid, formic acid, acetic acid, glycolic acid, methanesulfonic acid, oxalic acid, lactic acid, xylenesulfonic acid, toluenesulfonic acid, tartaric acid, propionic acid, benzoic acid, ascorbic acid, gluconic acid, malic acid, malonic acid, succinic acid, gallic acid, butyric acid, trifluoroacetic acid, and combinations thereof.

3. The process of claim 1 wherein the layer of the pyrazoline ligand is from about 5 to about 50 Angstroms thick.

4. The process of claim 1, wherein the pyrazoline ligand is present in an amount of 0.08 to 5 wt %, based on the total weight of the aqueous solution.

5. The process of claim 1, wherein the aqueous solution further comprises one or more additives selected from the group consisting of metal-chelating agents, corrosion-inhibiting compounds, surfactants, organic solvents, fluorides, fluoride equivalents, and phosphate-containing chelators.

6. The process of claim 1, further comprising rinsing the coated copper surface.

7. The process of claim 1, further comprising drying the coated copper surface.

8. A process for regenerating a substantially oxide-free copper surface comprising:
(a) contacting a substantially oxide-free copper surface with an aqueous solution comprising pyrazoline ligand and an organic acid to form a copper surface coated with a layer of the pyrazoline ligand, wherein the pyrazoline is 2-pyrazoline or 1-methyl-2-pyrazoline or a combination thereof, and the pH of the solution is about 2 to about 5.5;
(b) rinsing the coated copper surface;
(c) optionally drying the coated copper surface; and
(d) removing the pyrazoline ligand from the pyrazoline ligand coated copper surface by exposing the coated copper surface to reducing plasma to regenerate a substantially oxide-free copper surface.

9. The process of claim 8, wherein the organic acid is selected from the group consisting of citric acid, formic acid, acetic acid, glycolic acid, methanesulfonic acid, oxalic acid, lactic acid, xylenesulfonic acid, toluenesulfonic acid, tartaric acid, propionic acid, benzoic acid, ascorbic acid, gluconic acid, malic acid, malonic acid, succinic acid, gallic acid, butyric acid, trifluoroacetic acid, and combinations thereof.

10. The process of claim 8, wherein the aqueous solution further comprises one or more additives selected from the group consisting of metal-chelating agents, corrosion-inhibiting compounds, surfactants, organic solvents, fluorides, fluoride equivalents, and phosphate-containing chelators.

11. An aqueous solution comprising pyrazoline ligand, an organic acid and one or more additives selected from the group consisting of metal-chelating agents, corrosion-inhibiting compounds, surfactants, organic solvents, fluorides, fluoride equivalents, and phosphate-containing chelators, wherein the pyrazoline is 2-pyrazoline or 1-methyl-2-pyrazoline or a combination thereof, and the pH of the solution is about 2 to about 5.5.
